(19) United States
(12) Patent Application Publication
(10) Pub. No.: US 2011/0103873 A1
(43) Pub. Date: May 5, 2011

(54) Makeup assembly with light-emitting means

(76) Inventor: Yu-Hsing Chou, Tainan City (TW)

(21) Appl. No.: 12/588,816

(22) Filed: Oct. 29, 2009

(51) Int. Cl. B43K 29/00; A45D 40/00; A45D 40/04; A46B 11/00

(52) U.S. Cl. 401/52; 401/195; 401/88; 401/68; 401/268

(57) ABSTRACT

A makeup assembly includes a holder block holding a battery set, LEDs and two metal conducting strips, a rotary operating member rotatable to move the metal conducting strips between an on position where the LEDs are electrically connected to the battery set to emit light and an off position where the LEDs are electrically disconnected from the battery set, a housing surrounding the rotary operating member and the holder block, and a light guide holder mounted in the front opening of the housing to hold a cosmetic product such as lipstick or brow brush and carrying a light guide substance for guiding emitted light from the LEDs toward a predetermined direction around the cosmetic product.

### BACKGROUND OF THE INVENTION

1. Field of the Invention

The present invention relates to makeup containers and more particularly, to a makeup assembly that provides a lighting function.

2. Description of the Related Art

Different designs of makeup containers may be used to hold different cosmetic materials having different physical properties to fit different access methods. When purchasing a makeup, cosmetic material quality is not the only factor to be considered. A consumer may also consider the design of the container of the makeup. An attractive design can attract consumers to buy the product. The factor of product design capable of attracting consumers' eyes has become a key point to raise market share.

Curvature beauty, color design, embossment, ornamental decoration, application of fluorescent substance and other measures may be taken to enhance the value of a container for cosmetic product. Further, a makeup may be equipped with a light emitting circuit to provide a lighting function. In order to hold a LED lamp circuit in a makeup, the container of the makeup is normally made in a rectangular shape. Thus, LEDs can be installed in corners of the rectangular container around the cosmetic product that is carried in the rectangular container.

Taiwan Patent Publication No. 587432 discloses a lipstick design entitled “Light guide bar type lipstick set”. According to this design, as shown in FIGS. 1 and 2, the lipstick set comprises a cylindrical container 1, a lipstick 11 mounted in the bottleneck 121 of the cylindrical container 1, and a light guide bar 13 mounted in the cylindrical container 1 and connected to two through holes 122 at two sides relative to the bottleneck 121. According to this design, the shape of the expanded body of the cylindrical container 1 and the shape of the slender lipstick 11 are not in a harmony. Further, the whole design is complicated.

Therefore, it is desirable to provide a makeup assembly, which eliminates the drawbacks of the above prior art design.

### SUMMARY OF THE INVENTION

The present invention has been accomplished under the circumstances in view. It is one object of the present invention to provide a makeup assembly, which is operable to move a cosmetic product in and out of a housing thereof when turning on/off light emitting devices.

To achieve this and other objects of the present invention, a makeup assembly comprises a rotary operating member, a holder block supported on the rotary operating member to hold a battery set, a plurality of light emitting devices and two metal conducting strips, a housing surrounding the rotary operating member and the holder block, a light guide holder mounted in the housing and carrying a light guide substance, and a cosmetic product mounted in the light guide holder. The cosmetic product can be, for example, a lipstick or brow brush. When rotating the rotary operating member forwards/backwards relative to the housing, an inside actuation block is forced to move the metal conducting strips between an on position where the light emitting devices, for example, LEDs are electrically connected to the battery set to emit light, and an off position where the light emitting devices are electrically disconnected from the battery set.

Therefore, when rotating the rotary operating member in one direction relative to the housing, the LEDs are turned on to emit light, facilitating the application of the cosmetic product in a dark place.

### BRIEF DESCRIPTION OF THE DRAWINGS

FIG. 1 is an exploded view of a lipstick tube according to the prior art.

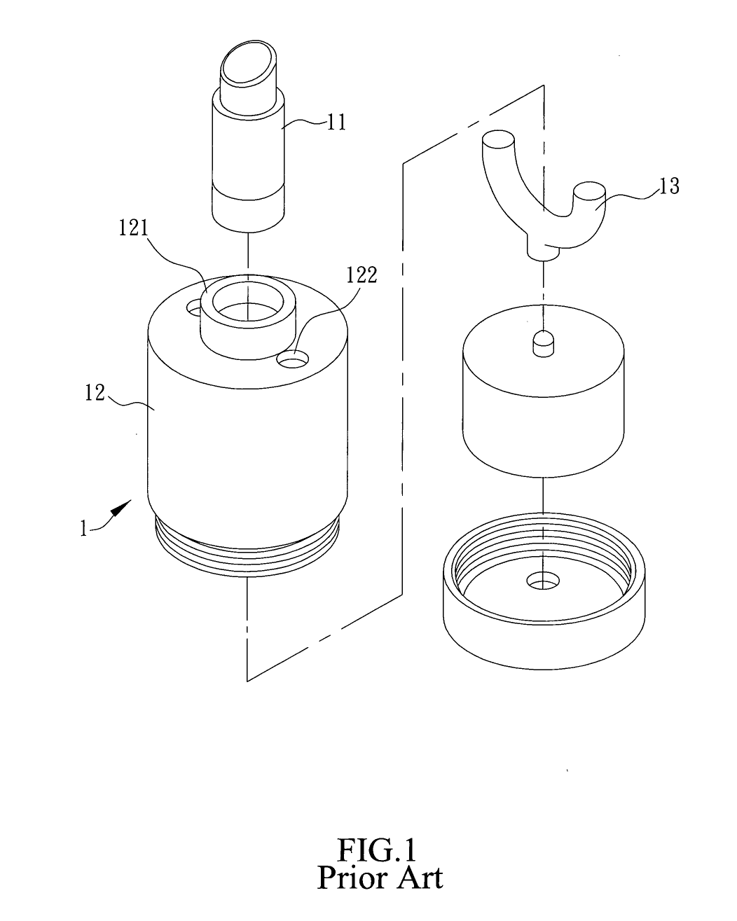

FIG. 2 is a sectional assembly view of the lipstick tube according to the prior art.

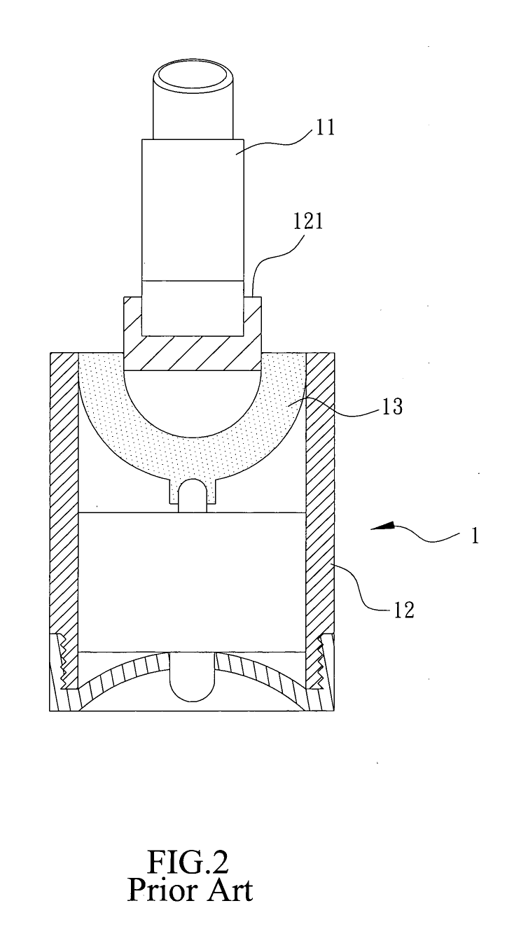

FIG. 3 is an exploded view of a lipstick tube according to the present invention.

FIG. 4 is an exploded view, showing different alternate forms of lipstick tubes according to the present invention.

FIG. 5 is a sectional assembly view of the lipstick tube shown in FIG. 3.

FIG. 6 is a schematic drawing showing an operation status of the lipstick tube according to the present invention.

FIG. 7 is a schematic drawing of the present invention, an eye-brush used instead of the lipstick.

### DETAILED DESCRIPTION OF THE PREFERRED EMBODIMENTS

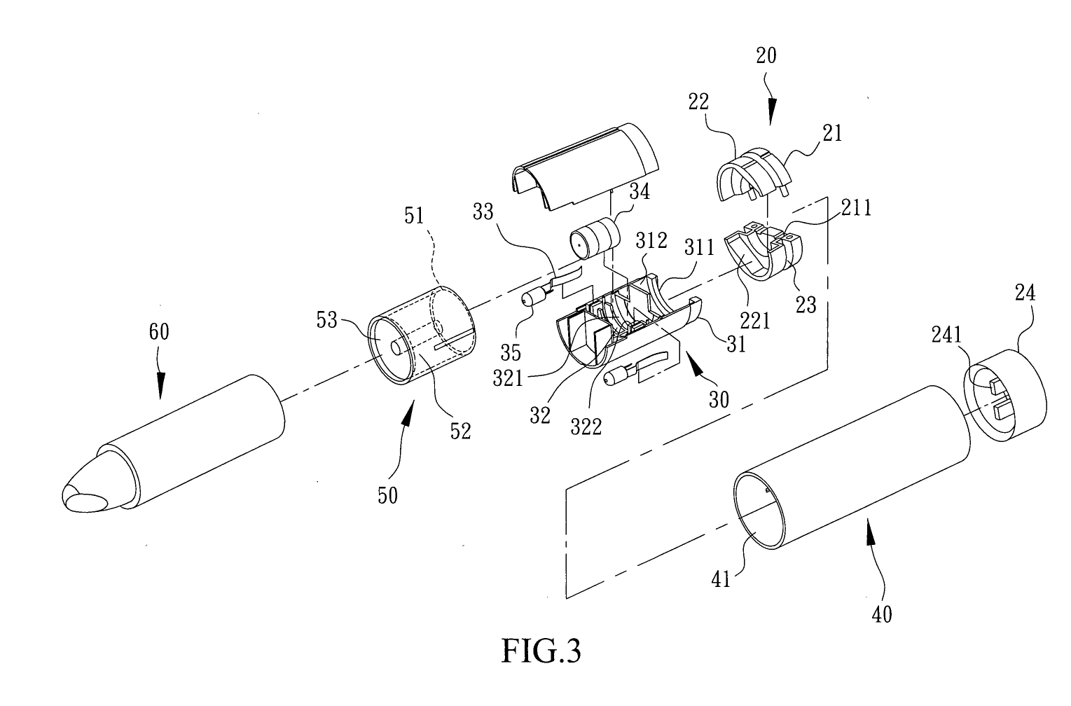

Referring to FIG. 3, a makeup container, for example, a lipstick tube in accordance with the present invention is shown comprising a rotary operating member 20, a holder block 30 supported on the rotary operating member 20, a battery set 34 accommodated in the holder block 30, light emitting devices 35 mounted in the holder block 30, two metal conducting strips 33 mounted in the holder block 30 and electrically connected between the battery set 34 and the light emitting devices (for example, light emitting diodes) 35, a housing 40 surrounding the rotary block 20 and the holder block 30, a light guide holder 50 mounted in the front opening 41 of the housing 40, and a lipstick 60 carried in the light guide holder 50.

The rotary operating member 20 is a stepped hollow cylinder formed of two symmetrical halves, comprising a relatively greater hollow cylindrical lower part 21, a plurality of plug holes 211 located on the bottom close end of the relatively greater hollow cylindrical lower part 21, a relatively smaller hollow cylindrical upper part 22, an annular step 23 defined between the relatively greater hollow cylindrical lower part 21 and the relatively smaller hollow cylindrical upper part 22 around the periphery, an inside actuation block 221 protruded from the inside wall of the relatively smaller hollow cylindrical upper part 22, and an end cap 24, which is capped on the relatively greater hollow cylindrical lower part 21 and has a plurality of plug rods 241 respectively tightly plugged into the plug holes 211 of the relatively greater hollow cylindrical lower part 21.

The holder block 30 is a hollow cylindrical member formed of two symmetrical halves, having an outer diameter corresponding to the relatively greater hollow cylindrical lower part 21 of the rotary operating member 20. The holder block 30 holds the light emitting devices 35 in the front open end thereof, having a bottom end wall 31, a circular hole 311 formed in the bottom end wall 31 and fitting the outer diameter of the relatively smaller hollow cylindrical upper part 22 of the rotary operating member 20, a receiving chamber 312 in communication with the circular hole 311, a plurality of inside partition walls 32 axially spaced above the receiving chamber 312, a plurality of circular holes 321 defined in the inside partition walls 32 for accommodating the battery set 34, and two locating grooves 322 defined in the inside partition walls 32 at two opposite sides for accommodating the metal conducting strips 33.

The housing 40 according to this embodiment is a hollow cylindrical shell having a front opening 41.

The light guide holder 50 is mounted in the front opening 41 of the housing 40, having a bottom wall 51 fitting the holder block 30 in diameter, an accommodation chamber 52 forwardly extended from the border of the bottom wall 51 for accommodating the lipstick 60 and a light guide substance 53 surrounding the accommodation chamber 52.

The lipstick 60 is mounted in the accommodation chamber 52 of the light guide holder 50.

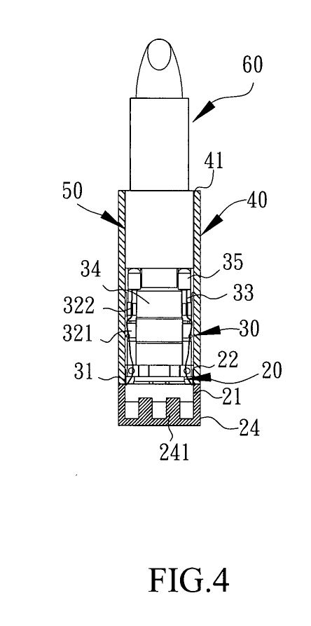

Referring to FIG. 4, the relatively smaller hollow cylindrical upper part 22 of the rotary operating member 20 is inserted into the circular hole 311 in the bottom end wall 31 of the holder block 30 to have the bottom end wall 31 be supported on the annular step 23 of rotary operating member 20 and the relatively smaller hollow cylindrical upper part 22 of rotary operating member 20 be received in the receiving chamber 312 of the holder block 30, and then install the battery set 34 in the circular holes 321 and the metal conducting strips 33 in the respective locating grooves 322, and then electrically connect the light emitting devices 35 to the metal conducting strips 33, and then set the parts thus assembled in the housing 40, and then fasten the light guide holder 50 to the front opening 41 of the housing 40, and then fasten the end cap 24 to the relatively greater hollow cylindrical lower part 21 of the rotary operating member 20 by plugging the respective plug rods 241 of the end cap 24 into the respective plug holes 211 of the relatively greater hollow cylindrical lower part 21, and then fasten the lipstick 60 to the accommodation chamber 52 of the light guide holder 50. When assembled, the rotary operating member 20 and the housing 40 are peripherally kept in flush.

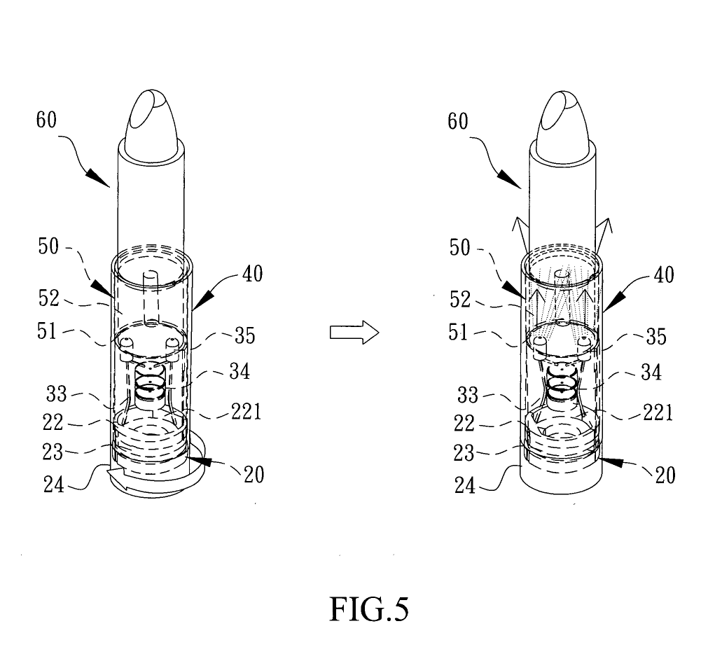

Referring to FIG. 5, when rotating the end cap 24, the inside actuation block 221 of the relatively smaller hollow cylindrical upper part 22 force the metal conducting strips 33 to curve into electric connection with the battery set 34, thereby causing the light emitting devices 35 to emit light. At this time, the light guide substance 53 of the light guide holder 50 guides the light emitted by the light emitting devices 35 out of the front opening 41 of the housing 40 around the lipstick 60 to provide a visual lighting effect. When reversing the end cap 24, the metal conducting strips 33 are released from the constraint of the inside actuation block 221 and returned to their former shape subject to their resilient material property, and therefore the light emitting devices 35 are turned off.

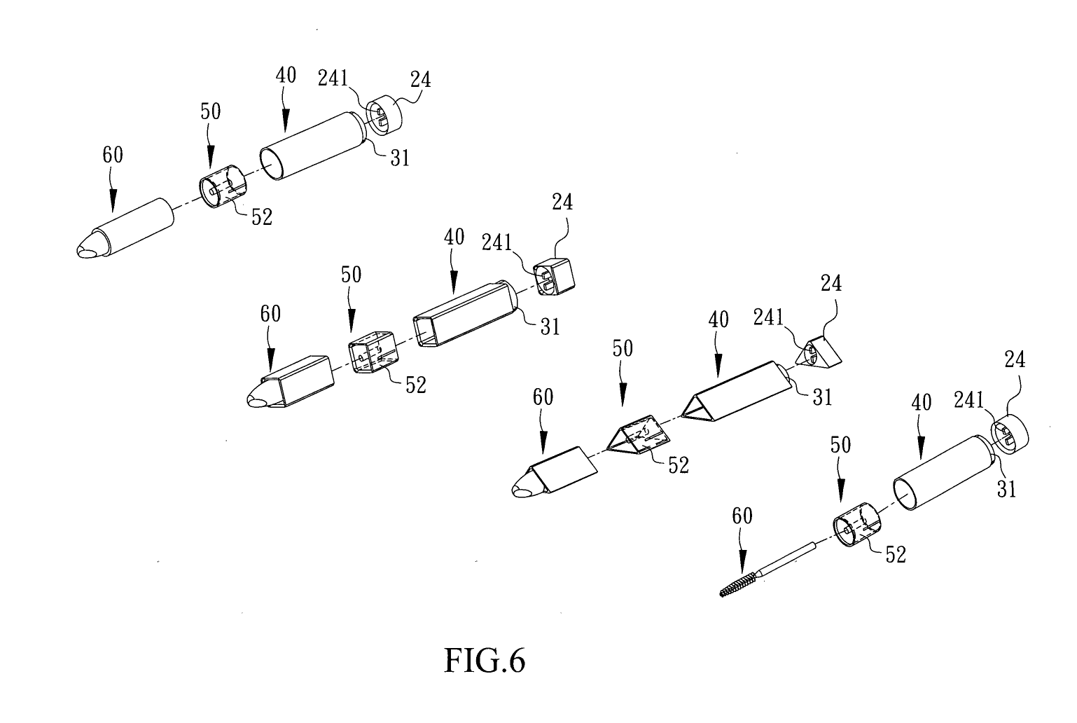

Referring to FIG. 6, by means of the connection arrangement between the light guide holder 50 and the housing 40, the shape design of the makeup container is free from the constraint of the dimension of the light guide substance 35. When using the makeup to color the lip or to coat the lip with a layer of protective substance in a dark place, the emitted light from the light emitting devices 35 provides sufficient illumination, facilitating lipstick application.

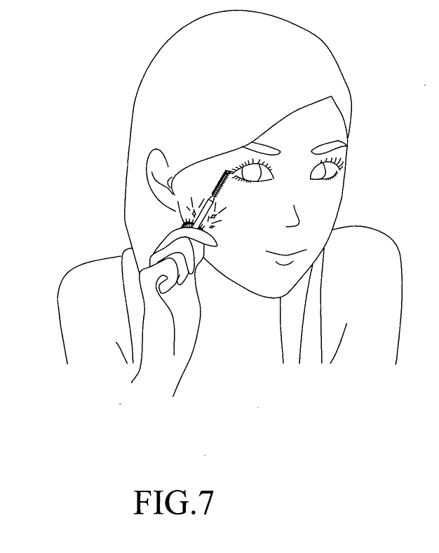

Referring to FIG. 7, a brow brush can be used with the makeup container of the present invention to substitute for the aforesaid lipstick 60.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A makeup assembly, comprising:
a rotary operating member, said rotary operating member comprising a relatively greater hollow cylindrical lower part, a plurality of plug holes located on a bottom close end of said relatively greater hollow cylindrical lower part, a relatively smaller hollow cylindrical upper part axially connected to said relatively greater hollow cylindrical lower part, an annular step defined between said relatively greater hollow cylindrical lower part and said relatively smaller hollow cylindrical upper part around the periphery thereof, an inside actuation block protruded from an inside wall of said relatively smaller hollow cylindrical upper part;
a holder block, said holder block comprising a bottom end wall, a circular hole formed in said bottom end wall for the insertion of said relatively smaller hollow cylindrical upper part of said rotary operating member, a receiving chamber in communication with said circular hole for receiving said relatively smaller hollow cylindrical upper part of said rotary operating member, a plurality of inside partition walls axially spaced above said receiving chamber, a plurality of circular holes defined in said inside partition walls, and two locating grooves defined in said inside partition walls at two opposite sides;
a battery set accommodated in the circular holes in said inside partition walls of said holder block;
a plurality of light emitting devices mounted in a front open side of said holder block;
two metal conducting strips respectively positioned in said locating grooves in said inside partition walls of said holder block and movable between an on position to electrically connect said light emitting devices to said battery set and an off position to electrically disconnect said light emitting devices from said battery set subject to rotary movement of said inside actuation block with said rotary operating member;
a housing surrounding said rotary operating member and said holder block, said housing comprising a front opening;
a light guide holder mounted in the front opening of said housing, said light guide holder comprising a bottom wall fitting said holder block in diameter, an accommodation chamber forwardly extended from the border of said bottom wall and a light guide substance surrounding the accommodation chamber for guiding light from said light emitting devices toward a predetermined direction; and
a cosmetic product mounted in the accommodation chamber of said light guide holder.

2. The makeup assembly as claimed in claim 1, further comprising an end cap capped on said relatively greater hollow cylindrical lower part of said rotary operating member, said end cap comprising a plurality of plug rods respectively tightly plugged into the plug holes of said relatively greater hollow cylindrical lower part of said rotary operating member.

3. The makeup assembly as claimed in claim 1, wherein said cosmetic product is a lipstick.

4. The makeup assembly as claimed in claim 1, wherein said cosmetic product is a brow brush.

5. The makeup assembly as claimed in claim 1, wherein said housing is prepared in one of circular shape, triangular shape, rectangular shape and oval shape.

6. The makeup assembly as claimed in claim 1, wherein said light guide holder is prepared in one of circular shape, triangular shape, rectangular shape and oval shape.
